(19) United States
(12) Patent Application Publication
(10) Pub. No.: US 2025/0370813 A1
(43) Pub. Date: Dec. 4, 2025

(54) DYNAMIC OPTIMIZATION WITH ACTIONABLE RECOMMENDATIONS

(71) Applicant: Kyndryl, Inc., New York, NY (US)

(72) Inventors: Anil Babu Boppanna, Bangalore (IN); Omar Odibat, Cedar Park, TX (US); Srinivas Gowda, Bangalore (IN)

(21) Appl. No.: 18/733,307

(22) Filed: Jun. 4, 2024

(51) Int. Cl. G06F 9/50

(52) U.S. Cl. CPC G06F 9/5033

(57) ABSTRACT

Embodiments calculate a request usage and a limit usage for a plurality of pods based on historical data, generate a recommendation for pod resources based on the calculated request usage and the calculated limit usage, and output a recommendation output message for approval which corresponds to the recommendation.

### BACKGROUND

Aspects of the present invention relate generally to dynamic optimization with actionable recommendations and, more particularly, to systems and methods for dynamic optimization with actionable recommendations for container resources.

A pod is a smallest execution unit for a container orchestration system and encapsulates at least one container. Further, when creating a pod, resources are specified for each container. The most common resources to specify for each container include a central processing unit (CPU) and memory.

### SUMMARY

In a first aspect of the invention, there is a computer-implemented method including: calculating, by a computing device, a request usage and a limit usage for a plurality of pods based on historical data, generating, by the computing device, a recommendation for pod resources based on the calculated request usage and the calculated limit usage, and outputting, by the computing device, a recommendation output message for approval which corresponds to the recommendation.

In another aspect of the invention, there is a computer program product including one or more computer readable storage media having program instructions collectively stored on the one or more computer readable storage media. The program instructions are executable to: calculate a request usage and a limit usage for a plurality of pods based on historical data; generate a forecasted usage graph which comprises a forecasted usage based on the historical data; generate a recommendation for pod resources based on the calculated request usage, the calculated limit usage, and the generated forecast usage graph which comprises the forecasted usage; and output a recommendation output message for approval which corresponds to the recommendation.

In another aspect of the invention, there is a system including a processor, a computer readable memory, one or more computer readable storage media, and program instructions collectively stored on the one or more computer readable storage media. The program instructions are executable to: calculate a request usage and a limit usage for a plurality of pods based on historical data; generate a forecasted usage graph which comprises a forecasted usage based on the historical data; generate a recommendation for pod resources based on the calculated request usage, the calculated limit usage, and the generated forecast usage graph which comprises the forecasted usage; and output a recommendation output message via a graphical user interface (GUI) for approval which corresponds to the recommendation. The forecasted usage includes a forecast of future resource usage.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of a dynamic optimization system in accordance with aspects of the present invention.

FIGS. 5-7 show examples of graphs corresponding to models of the dynamic optimization system in accordance with aspects of the present invention.

FIG. 8 shows an example of a forecasted usage graph of the dynamic optimization system in accordance with aspects of the present invention.

FIG. 9 shows an example of a graphical user interface (GUI) of the dynamic optimization system in accordance with aspects of the present invention.

FIG. 10 shows a flowchart of an exemplary method of the dynamic optimization system in accordance with aspects of the present invention.

FIGS. 11 and 12 show a flowchart of an exemplary merge computation method of the dynamic optimization system in accordance with aspects of the present invention.

FIG. 13 shows another flowchart of an exemplary method of the dynamic optimization system in accordance with aspects of the present invention.

FIG. 14 shows another flowchart of an exemplary method of the dynamic optimization system in accordance with aspects of the present invention.

### DETAILED DESCRIPTION

Aspects of the present invention relate generally to dynamic optimization with actionable recommendations and, more particularly, to systems and methods for dynamic optimization with actionable recommendations for container resources. Aspects of the present invention may be implemented as a system, method, or computer program product. The system, method, or computer program product validates resource utilization by performing machine learning using a machine learning model included in a utilization calculator module. In addition, the system, method, or computer program product provides a recommendation engine to label at least one pod, in addition to a recommendation to generate optimum resource values. The system, method, and/or computer program product also provides a forecasting model for real time validation of the provided recommendation associated with the generated optimum resource values. The systems and methods provided herein may be computer implemented methods.

More specifically, the system, method, or computer program product described herein provides dynamic optimization of container resources. The system, method, or computer program product also validates a resource usage estimator function using a machine learning model. Further, the system, method, or computer program product generates labels, such as underutilized, overutilized, and normal utilization based on historical usage, as well as generates recommendations on optimal configuration values based on a usage pattern. Embodiments also recommend optimal values for missing configurations within the container resources. Moreover, aspects of the present invention are directed to real-time dynamic validation of generated recommendations by utilizing a forecasting model.

The system, method, or computer program product provides efficient resource utilization by optimizing resources and removing unused resources. In this way, it is possible to reduce the cost of running an application. Further, the system, method, or computer program product ensures that applications are available, stable, and function properly, and also improve the utilization of an operations team and resource by reducing the time and effort needed for application deployment and application management. In addition, embodiments of the present invention provide better visibility of resource usage. The system, method, or computer program product may dynamically optimize actionable recommendations for container resources. Accordingly, implementations of the present invention provide an improvement in the technical field of resource optimization and allocation of at least one container.

In contrast, known systems simply kill (i.e., shut down) processes in response to the processes running out of memory and throttle processes in response to a CPU consumption being higher than the actual limits. Accordingly, known systems and methods do not provide planning for cloud resources, and thus overprovision resources. Further, known systems and methods do not provide visibility into usages and costs such that cloud resources become idle, and result in fragmentation of cloud usage. The systems, methods, and computer program products as described herein make improvements on the known systems by providing dynamic optimization of container resources to improve visibility and planning for cloud resources.

Implementations of the present invention are also rooted in computer technology. For example, the steps of calculating, by a computing device, a request usage and a limit usage for each pod based on historical data, generating, by the computing device, a recommendation for pod resources based on the calculated request usage and the calculated limit usage, and outputting, by the computing device, a recommendation output message for approval which corresponds to the recommendation are computer-based and cannot be performed in the human mind. For example, calculating a request usage and a limit usage using a machine learning model is, by definition, performed by a computer and cannot practically be performed in the human mind (or with pen and paper) due to the complexity and massive amounts of calculations involved. Given the scale and complexity of calculating a request usage and a limit usage using a machine learning model, it is simply not possible for the human mind, or for a person using pen and paper, to perform the number of calculations involved in calculating a request usage and a limit using a machine learning model and generating a recommendation for pod resources based on the calculated request usage and the calculated limit usage in real-time, amongst other features described herein that are also root in computer technology.

It should be understood that, to the extent implementations of the invention collect, store, or employ personal information provided by, or obtained from, individuals (for example, users associated with service tickets), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

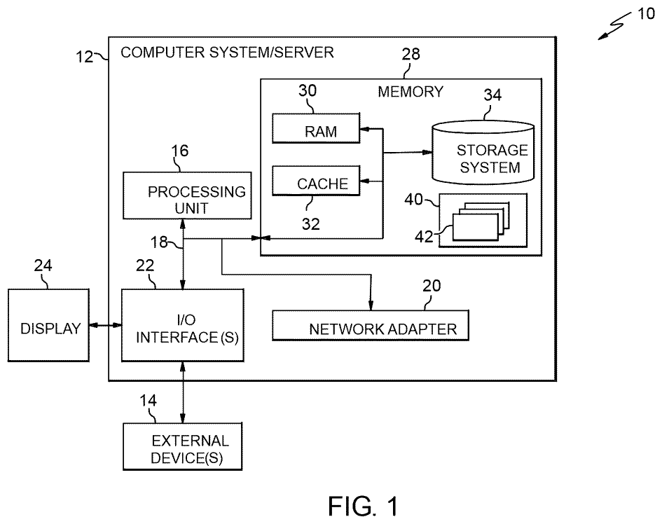

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

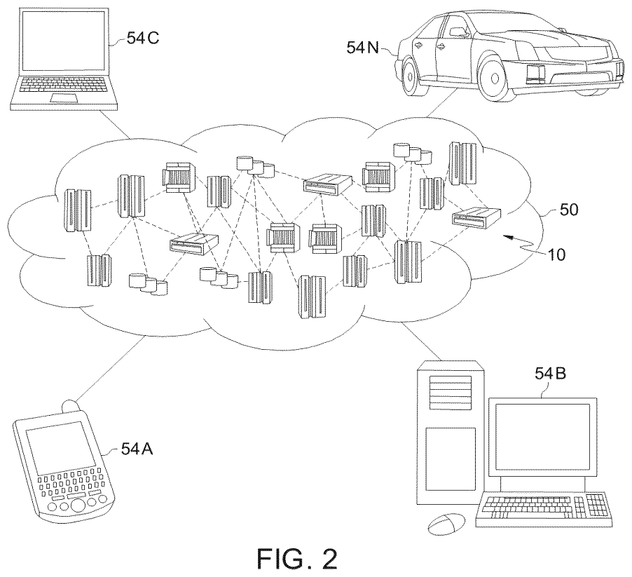

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

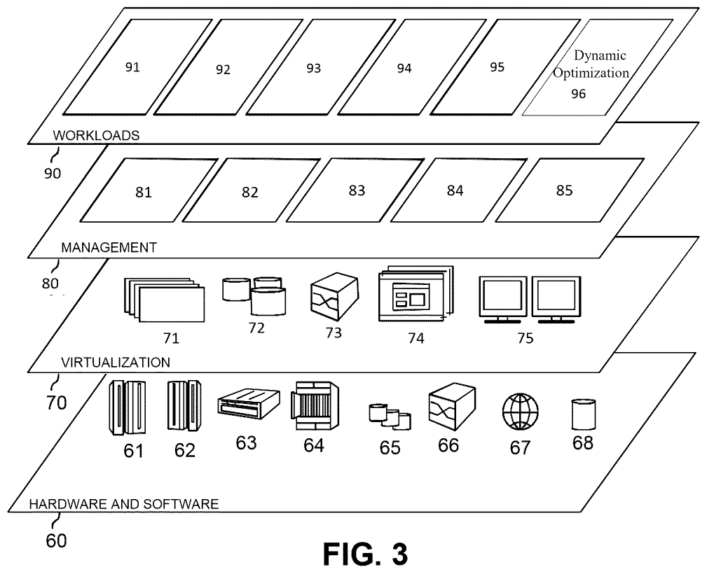

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamic optimization 96.

Implementations of the invention may include a computer system/server 12 of FIG. 1 in which one or more of the program modules 42 are configured to perform (or cause the computer system/server 12 to perform) one of more functions of the dynamic optimization 96 of FIG. 3.

For example, the one or more of the program modules 42 of the dynamic optimization 96 may be configured to: calculate a request usage and a limit usage for each pod based on historical data; generate a recommendation for pod resources based on the calculated request usage and the calculated limit usage; and output a recommendation output message for approval which corresponds to the recommendation.

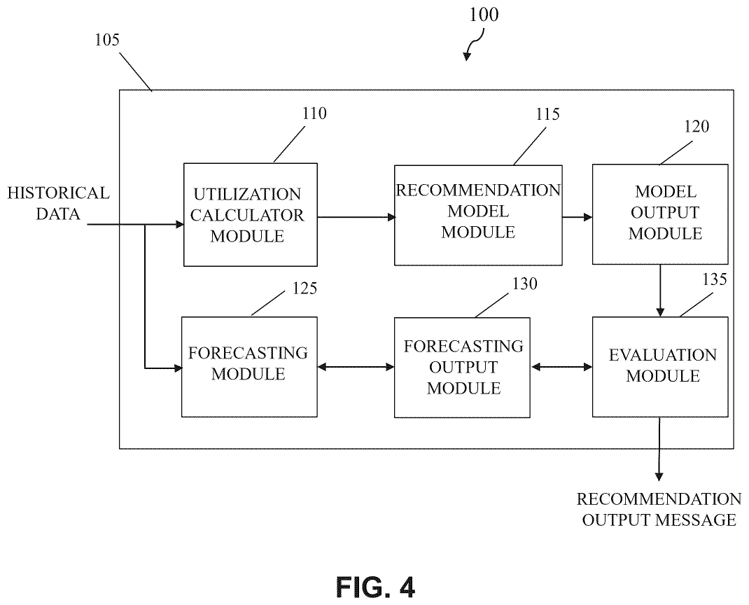

FIG. 4 shows a block diagram of a dynamic optimization system in accordance with aspects of the invention. In embodiments, the dynamic optimization system 100 comprises a dynamic optimization environment 105 which includes a utilization calculator module 110, a recommendation model module 115, a model output module 120, a forecasting module 125, a forecasting output module 130, and an evaluation module 135, each of which may comprise one or more program modules such as program modules 42 described with respect to FIG. 1 and the dynamic optimization 96.

The dynamic optimization system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the utilization calculator module 110 receives historical data (e.g., pod data and resource usage) from an external system (e.g., external container system) and calculates a resource utilization metric based on the historical data. For example, the utilization calculator module 110 calculates the resource utilization metric RU for each pod based on an exponential weighted moving average (EWMA), static weights W1, W2, W3, probability of being in the 90^{th} percentile P^{90th}, and a simple moving average SMA. In this example, the RU is calculated as follows:

$$Resource Utilization Metric R U = E W M A * W 1 + {P}^{90 th} * W 2 + S M A * W 3 ( resource utilizationmetric ) .$$

In embodiments, the probability of being in the 90^{th} percentile P^{90th} represents a probability of the resource utilization metric RU being in the 90^{th} percentile for that resource. Further, in aspects of the present invention, the static weight of W1 is 0.5, the static weight of W2 is 0.4, and the static weight of W3 is 0.1. However, the static weights W1, W2, and W3 and probability of being in a percentile are not limited to this example. In particular, a machine learning model of the utilization calculator module 110 validates these static weights W1, W2, and W3 and may recommend different static weights W1, W2, and W3 based on an output of the machine learning model. For example, in response to the machine learning model determining that the static weights W1, W2, and W3 are inaccurate (i.e., have a low confidence level based on historical data), the machine learning model determines new static weights W1, W2, and W3 which are accurate (i.e., have a high confidence level based on the historical data). In an example, the machine learning model comprises a random forest model with multiple decision trees for capturing feature importance for the resource utilization metric RU. However, embodiments are not limited to this example, and the machine learning model may also comprise a model using a Shapley method or a model using permutation feature importance as other non-limiting examples.

In FIG. 4, the utilization calculator module 110 calculates the resource utilization metric RU for a request usage RESU. In embodiments, the RESU is calculated as follows:

$$Request Usage R E S U = E W M A for request * 0.5 + {P}^{90 th} * 0.4 + S M A for request * 0.1 ( request usage ) .$$

In embodiments, the probability of being in the 90^{th} percentile P^{90th} represents a probability of the request usage being in the 90^{th} percentile. In embodiments, the probability of the request usage being in the 90^{th} percentile is important because overutilization of a resource occurs at 90% of an upper threshold value of a resource. However, the probability of being in the 90^{th} percentile is only an example such that other percentiles may be used as the upper threshold value of the request usage. Further, the exponential moving average EWMA gives a higher weighting to recent historical data while the SMA assigns an equal weighting to all historical data.

In FIG. 4, the utilization calculator module 110 further calculates the resource utilization metric RU for a limit usage LU. In embodiments, the LU is calculated as follows:

$$Limit Usage L U = E W M A for limit * 0.5 + {P}^{90 th} * 0.4 + S M A for limit * 0.1 ( limit usage ) .$$

In embodiments, the probability of being in the 90^{th} percentile P^{90th} represents a probability of the limit usage being in the 90^{th} percentile. In embodiments, as discussed above, the probability of the limit usage being in the 90^{th} percentile may be used because overutilization of a resource occurs at 90% of an upper threshold value of a resource. However, the probability of being in the 90^{th} percentile is only an example such that other percentiles may be used as the upper threshold value of the limit usage. Then, the utilization calculator module 110 sends the request usage RESU and the limit usage LU for each pod to the recommendation model module 115.

Still referring to FIG. 4, the recommendation model module 115 receives the request usage RESU and the limit usage LU for each pod. In aspects of the present invention, the recommendation model module 115 receives the request usage RESU and the limit usage LU for each pod from the utilization calculator module 110. The recommendation model module 115 determines whether there is at least one pod with both a request and limits missing. The recommendation model module 115 generates a recommendation with the request being a current usage value and a limit being a higher value of one of a maximum usage value and the current usage value plus a lower threshold value (e.g., 50%) of the current usage value, in response to determining that at least one pod has both the request and limits missing.

In embodiments, the recommendation model module 115 comprises a rule based recommendation engine (RE) which includes rules that are formulated based on domain knowledge that is validated by subject matter experts (SMEs). In embodiments, the rule based recommendation engine (RE) of the recommendation model module 115 checks a health of existing configurations in response to finding faulty recommended new values. In particular, the rule based recommendation engine (RE) of the recommendation model module 115 generates optimal configuration values even if configuration values are missing for a pod. For example, the rule based recommendation engine (RE) of the recommendation model module 115 generates a limit recommendation in response to determining that a limit usage of a pod is missing. The recommendation model module 115 considers all possible scenarios in which a pod can fail.

In further embodiments of FIG. 4, the recommendation model module 115 determines whether there is at least one pod with only limits missing in response to determining that there is no pod with both the request and limits missing. The recommendation model module 115 determines whether the request usage is less than the lower threshold value (e.g., 50%) of a request value in response to determining that there is at least one pod with only limits missing. The recommendation model module 115 generates a recommendation with the request being a current usage value+a predetermined percentage (e.g., 25%) of the request value and the limits being the request the lower threshold value (e.g., 50%) of (a higher value of one of the request and a maximum usage value) in response to determining that the request usage is less than the lower threshold value (e.g., 50%) of the request value. In this scenario, the recommendation model module 115 also determines that the dynamic optimization system 100 has an under utilization of resources. The recommendation model module 115 generates a recommendation with the limits being a current request+the lower threshold value (e.g., 50%) of (a higher value of one of the current request and the maximum usage value) in response to determining that that the request usage is not less than the lower threshold value (e.g., 50%) of the request value.

In further aspects of the present invention with regards to FIG. 4, the recommendation model module 115 determines whether there is at least one pod with only the request missing in response to determining that there is no pod with only limits missing. The recommendation model module 115 determines whether the limit usage is greater than an upper threshold value (e.g., 90%) of a limit value in response to determining that there is at least one pod with only the request missing. The recommendation model module 115 generates a recommendation with the request being the current usage value and the limits being the limits usage value+the predetermined percentage (e.g., 25%) of the limits usage value in response to determining that the limit usage is greater than the upper threshold value (e.g., 90%) of the limit value. In this scenario, the recommendation model module 115 determines that the dynamic optimization system 100 has an over utilization of resources. The recommendation model module 115 generates a recommendation with the request being the current usage value in response to determining that the limit less is not greater than an upper threshold value (e.g., 90%) of the limit value.

Still referring to FIG. 4, the recommendation model module 115 further determines that there is at least one pod with no missing request and no missing limits. The recommendation model module 115 determines whether the request usage is less than the lower threshold value (e.g., 50%) of a request value in response to determining that there is at least one pod with no missing request and no missing limits. The recommendation model module 115 generates a recommendation with the request being the current usage value+the predetermined percentage (e.g., 25%) of the request value and the limits being the request+the lower threshold value (e.g., 50%) of (a higher value of one of the request and the maximum usage value) in response to determining that the request usage is less than the lower threshold value (e.g., 50%) of the request value. In this scenario, the recommendation model module 115 also determines that the dynamic optimization system 100 has an under utilization of resources.

In aspects of the present invention in FIG. 4, the recommendation model module 115 also determines whether the limit usage is greater than the upper threshold value (e.g., 90%) of the limit value in response to determining that the request usage is not less than the lower threshold value (e.g., 50%) of the request value. The recommendation model module 115 generates a recommendation with the limits being the limits usage value+the predetermined percentage (e.g., 25%) of the limits usage value in response to determining that the request usage is greater than the upper threshold value (e.g., 90%) of the limit value. In this scenario, the recommendation model module 115 also determines that the dynamic optimization system 100 has an over utilization of resources. The recommendation model module 115 does not give any recommendation in response to determining that the request usage is not greater than the upper threshold value (e.g., 90%) of the limit value. In this scenario, the recommendation model module 115 also determines that the dynamic optimization system 100 has a normal utilization of resources.

The recommendation model module 115 outputs the recommendation of at least one of the request and the limits to the module output module 120 in response to the recommendation model module 115 generating the recommendation. Further, the recommendation model module 115 outputs a normal utilization signal and no recommendation to the model output module 120 in response to the recommendation model module 115 determining that the dynamic optimization system 100 have the normal utilization of resources.

Still referring to FIG. 4, the model output module 120 receives the recommendation of at least one of the request and the limits in response to the recommendation model module 115 generating the recommendation. In this scenario, the model output 120 outputs the recommendation of at least one of the request and the limits to the evaluation module 135. In this scenario, the evaluation module 135 receives the recommendation of at least one of the request and the limits and outputs a recommendation output message through a graphical user interface (GUI) of a computing device. The recommendation output message corresponds with the recommendation of that least one of the request and the limits. In particular, the GUI of the computing device enables a user to accept the recommendation or reject the recommendation through an accept recommendation button or a reject recommendation button. In further embodiments, the user is able to press the accept recommendation button or the reject recommendation button by at least one of a touchscreen of a display of the computing device and a mouse pointer on the display of the computing device.

In further embodiments of the present invention, the model output module 120 receives the normal utilization signal in response to the recommendation model module 115 determining that the dynamic optimization system 100 has a normal utilization of resources. In this scenario, the model output 120 does not output any recommendation to the evaluation module 135.

In FIG. 4, the evaluation module 135 also outputs the recommendation of at least one of the requests and the limits to the forecasting module 125 via the forecasting output module 130. In embodiments of the present invention, the forecasting module 125 receives the historical data and the recommendation of at least one of the request and the limits from the evaluation module 135 and generates a forecasted usage graph based on the received historical data and the recommendation of at least one of the request and the limits. In particular, the forecasting module 125 utilizes a machine learning model with pattern recognition to generate the forecasted usage graph. For example, the machine learning model with pattern recognition of the forecasting module 125 comprises at least one of decision trees, neural networks, and support vector machines (SVM). In further embodiments, the forecasted usage graph comprises a forecasted resource usage for a future timeline. The forecasting module 125 sends the forecasted usage graph to the forecasting output module 130.

In further embodiments of FIG. 4, the forecasting output module 130 receives the forecasted usage graph comprising the forecasted resource usage for a future timeline and generates a forecasted recommendation of at least one of a future request and future limits based on the forecasted usage graph. The forecasting output module 130 sends the generated forecasted recommendation of at least one of the future request and the future limits to the evaluation module 135.

In further embodiments of FIG. 4, the evaluation module 135 receives the recommendation of at least one of the request and the limits from the model output module 120 and the generated forecasted recommendation of at least one of the future request and the future limits from the forecasting output module 130 and outputs the recommendation output message through the graphical user interface (GUI) of the computing device based on the recommendation of at least one of the request and the limits from the model output module 120 and the generated forecasted recommendation of at least one of the future request and the future limits from the forecasting output module 130. The recommendation output message corresponds with the recommendation of at least one of the request and the limits and the generated forecasted recommendation of at least one of the future request and the future limits. In particular, the GUI of the computing device enables a user to accept the recommendation or reject the recommendation through the accept recommendation button or the reject recommendation button. In further embodiments, the user is able to press the accept recommendation button or the reject recommendation button by at least one of the touchscreen of the display of the computing device and a mouse pointer on the display of the computing device.

In aspects of the present invention, the forecasting module 125 generates the forecasted usage graph and the forecasting output module 130 generates the forecasted recommendation of at least one of the future request and the future limits based on the forecasted usage graph are dynamically performed based on a user request. Accordingly, in embodiments of the present invention, the evaluation module 135 may receive only the recommendation from the model output module 120. In another embodiment, the evaluation module 135 may receive the recommendation from the model output module 120 and the generated forecasted recommendation from the forecasting output module 130. In this latter scenario, the evaluation module 135 outputs the recommendation output message based on equal weights given to the recommendation from the model output module 120 and the generated forecasted recommendation from the forecasting output module 130.

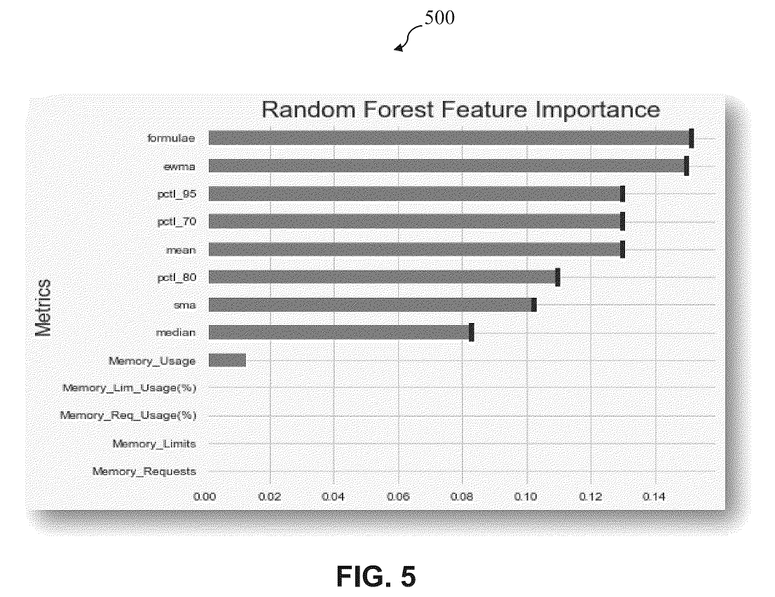

FIGS. 5-7 show examples of graphs corresponding to models of the dynamic optimization system in accordance with aspects of the present invention. In FIG. 5, a graph 500 of the utilization calculation module 110 shows a random forest feature importance with metrics on the y axis and a numerical representation of the feature importance on the x axis. For example, by using the random forest model, the graph 500 is generated which shows that the formulae has a highest feature importance, exponential weighted moving average (EWMA) has a second highest feature importance, and simple moving average (SMA) has a third lowest feature importance.

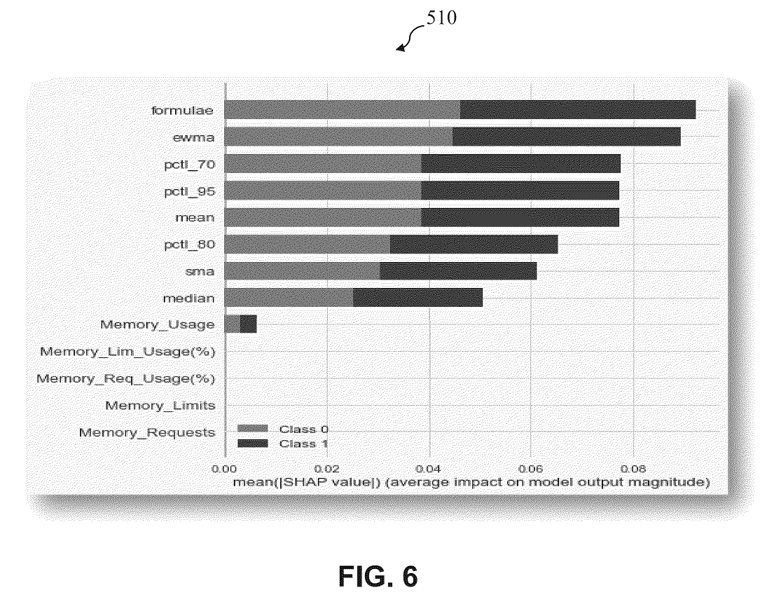

In FIG. 6, a graph 510 of the utilization calculation module 110 shows Shapley values with metrics on the y axis and a numerical representation of an average impact on model output magnitude of Shapley values on the x axis. In embodiments, Shapley values calculate an average marginal contribution of a feature towards a model score. In particular, by using the Shapley values, the graph 510 includes two classes (e.g., class 0 and class 1) which are used to determine feature importance using the Shapley method.

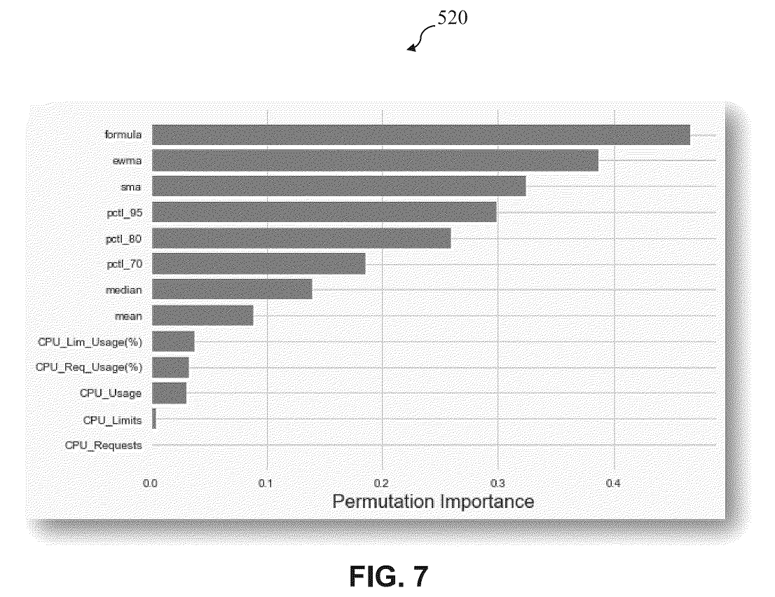

In FIG. 7, a graph 520 of the utilization calculation model 110 shows a permutation feature importance with metrics on the y axis and a numerical representation of permutation importance on the x axis. In embodiments, permutation feature importance measures a change in model error after a single model feature value has been permuted (i.e., shuffled). In particular, by using the permutation feature importance, the graph 520 determines feature importance by shuffling the feature values.

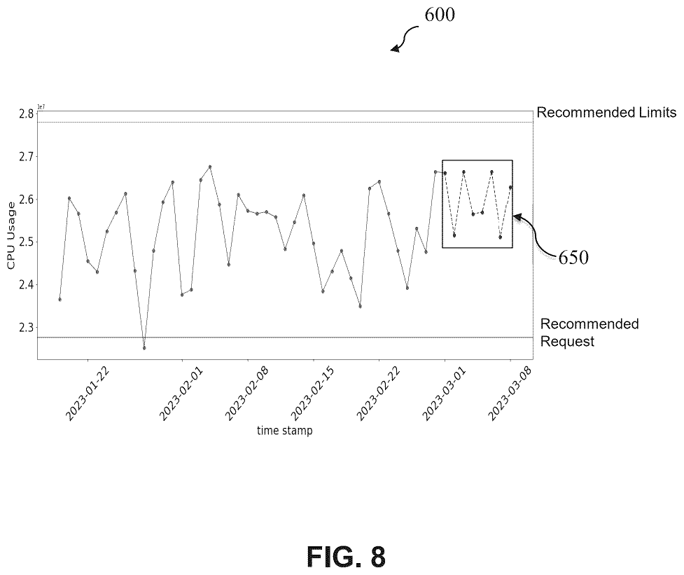

FIG. 8 shows an example of a forecasted usage graph of the dynamic optimization system in accordance with aspects of the present invention. In embodiments, the forecasted usage graph 600 includes a CPU usage on the y axis and a time stamp on the x axis. In the forecasted usage graph 600 generated by the forecasting module 125, a forecasted usage 650 is represented by the rectangle in a portion of the forecasted usage graph 600. The forecasted usage 650 represents a forecast of a resource usage for a future timeline. In the forecasted usage graph 600, the forecasted usage 650 represents the forecast of a resource usage in a future timeline past Mar. 1, 2023. In this embodiment, the current date is Mar. 1, 2023 and the forecasted usage graph 600 generates the forecasted usage 650 based on historical data and the recommendation of at least one of the request and the limits from the evaluation module 135.

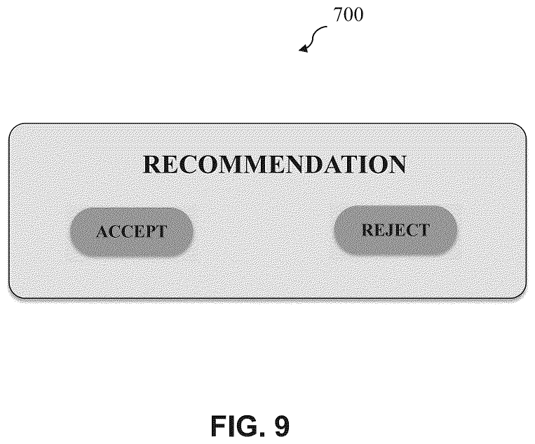

FIG. 9 shows an example of a graphical user interface (GUI) of the dynamic optimization system in accordance with aspects of the present invention. In FIG. 9, the graphical user interface (GUI) 700 shows the recommendation and allows the user to accept the recommendation using an accept button or reject the recommendation using the reject button.

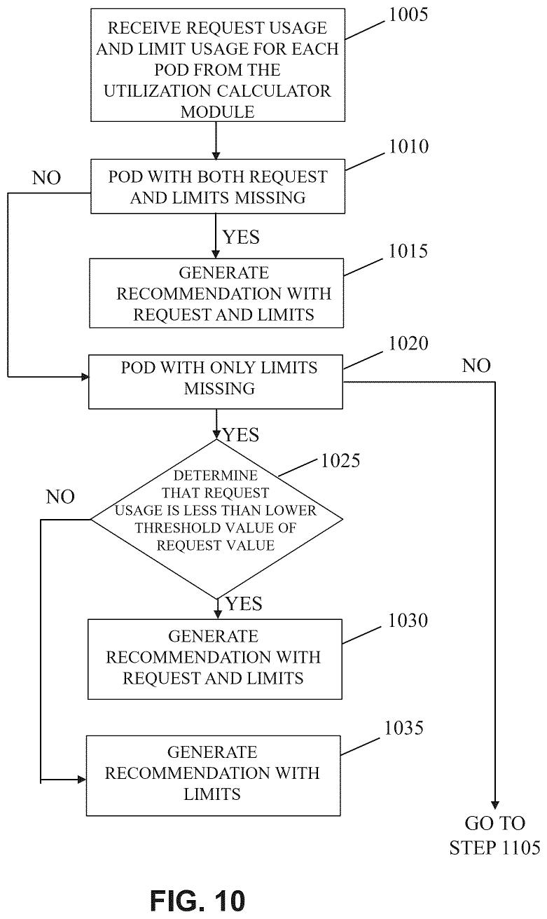

FIG. 10 shows a flowchart of an exemplary method of the merge computation system in accordance with aspects of the present invention. Steps of the method may be carried out in the recommendation model module 115 in the environment of FIG. 4.

At step 1005, the system receives, at the recommendation model module 115, a request usage and limit usage for each pod. In embodiments and as described with respect to FIG. 4, the recommendation model module 115 receives the request usage and the limit usage from the utilization calculator module 110.

At step 1010, the system determines, at the recommendation model module 115, whether there is at least one pod with both a request and limits missing. At step 1015, the system generates, at the recommendation model module 115, a recommendation with the request being a current usage value and the limits being (a higher value of one of a maximum usage value and the current usage value)+the lower threshold value (e.g., 50%) of the current usage value in response to determining that at least one pod has both the request and the limits missing.

At step 1020, the system determines, at the recommendation model module 115, whether there is at least one pod with only limits missing in response to determining that there is no pod with both the request and the limits missing. At step 1025, the system determines, at the recommendation model module 115, whether the request usage is less than the lower threshold value (e.g., 50%) of a request value in response to determining that there is at least one pod with only limits missing. At step 1030, the system generates, at the recommendation model module 115, a recommendation with a request being a current usage value+the predetermined percentage (e.g., 25%) of the request value and limits being the request+the lower threshold value (e.g., 50%) of (a high value of one of the request and a maximum usage value) in response to determining that the request usage is less than the lower threshold value (e.g., 50%) of the request value. In embodiments and as described with respect to FIG. 4, the recommendation model module 115 determines that the dynamic optimization system 100 has an under utilization of resources.

At step 1035, the system generates, at the recommendation model module 115, a recommendation with the limits being a current request+the lower threshold value (e.g., 0.50%) of (a high value of one of the current request and the maximum usage value) in response to determining that the request usage is not less than the lower threshold value (e.g., 50%) of the request value.

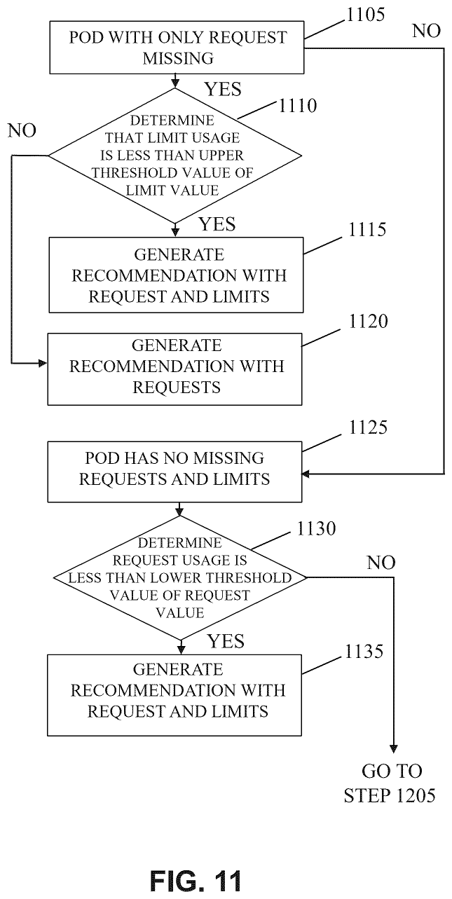

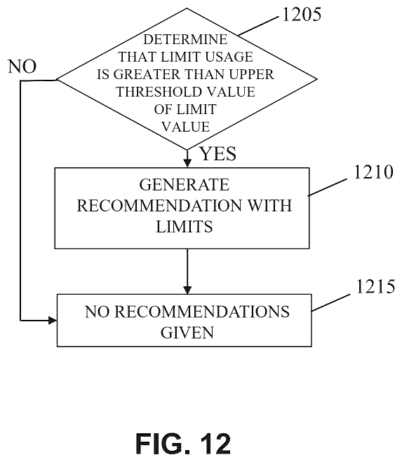

FIGS. 11 and 12 show a flowchart of an exemplary method of the merge computation system in accordance with aspects of the present invention. Steps of the method may be carried out in the recommendation model module 115 in the environment of FIG. 4. FIG. 11 continues from step 1020 of FIG. 10 and FIG. 12 continues from step 1130 of FIG. 11.

At step 1105, the system determines, at the recommendation model module 115, whether there is at least one pod with only the request missing in response to determining that there is no pod with only limits missing. At step 1110, the system determines, at the recommendation model module 115, whether the limit usage is greater than the upper threshold value (e.g., 90%) of a limit value in response to determining that there is at least one pod with only the request missing. At step 1115, the system generates, at the recommendation model module 115, a recommendation with the request being a current usage value and the limits being the limits usage value+the predetermined percentage (e.g., 25%) of the limits usage value in response to determining that the limit usage is greater than the upper threshold value (e.g., 90%) of the limit value. In embodiments and as described with respect to FIG. 4, the recommendation model module 115 determines that the dynamic optimization system 100 has an over utilization of resources. At step 1120, the system generates, at the recommendation model module 115, a recommendation with the request being the current usage value in response to determining that the limit usage is not greater than the upper threshold value (e.g., 90%) of the limit value.

At step 1125, the system determines, at the recommendation model module 115, that there is at least one pod with no missing request and no missing limits in response to determining that there no pod with only the request missing. At step 1130, the system determines, at the recommendation model module 115, whether the request usage is less than the lower threshold value (e.g., 50%) of a request value in response to determining that there is at least one pod with no missing request and no missing limits.

At step 1135, the system generates, at the recommendation model module 115, a recommendation with the request being the current usage value+the predetermined percentage (e.g., 25%) of the request value and the limits being the request+the lower threshold value (e.g., 50%) of (a higher value of one of the request and the maximum usage value) in response to determining that the request usage is less than the lower threshold value (e.g., 50%) of the request value. In embodiments and as described with respect to FIG. 4, the recommendation model module 115 determines that the dynamic optimization system 100 has an under-utilization of resources.

In FIG. 12, at step 1205, the system determines, at the recommendation model module 115, whether the limit usage is greater than the upper threshold value (e.g., 90%) of the limit value in response to determining that the request usage is not less than the lower threshold value (e.g., 50%) of the request value. At step 1210, the system generates, at the recommendation model module 115, a recommendation with the limits being the limits usage value+the predetermined percentage (e.g., 25%) of the limits usage value in response to determining that the request usage is greater than the upper threshold value (e.g., 90%) of the limit value. In embodiments and as described with respect to FIG. 4, the recommendation model module 115 determines that the dynamic optimization system 100 has an over utilization of resources. At step 1215, the system does not generate, at the recommendation model module 115, any recommendation in response to determining that the request usage is not greater than the upper threshold value (e.g., 90%) of the limit value. In embodiments and as described with respect to FIG. 4, the recommendation model module 115 determines that the dynamic optimization system 100 has a normal utilization of resources.

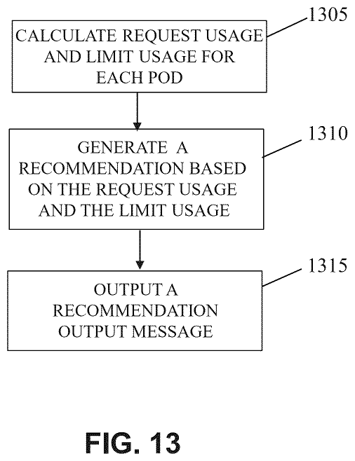

FIG. 13 shows another flowchart of an exemplary method of the dynamic optimization system in accordance with aspects of the present invention. Steps of the method may be carried out in the environment of FIG. 4.

At step 1305, the system calculates, at the utilization calculator module 100, a request usage and a limit usage for each pod based on historical data. At step 1310, the system generates, at the recommendation model module 115, a recommendation based on the request usage and the limit usage. At step 130, the system outputs, at the evaluation module 135, a recommendation output message based on the generated recommendation.

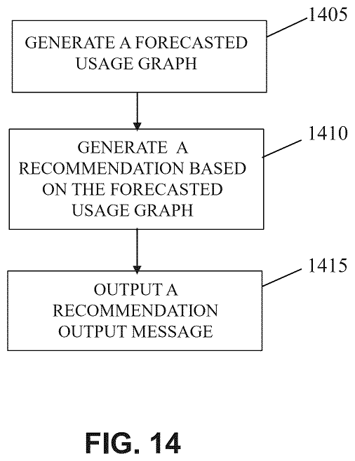

FIG. 14 shows a flowchart of an exemplary method of the dynamic optimization system in accordance with aspects of the present invention. Steps of the method may be carried out in the environment of FIG. 4.

At step 1405, the system generates, at the forecasting module 125, a forecasted usage graph based on the received historical data and the recommendation of at least one of the request and the limits. At step 1410, the system generates, at the forecasting output module 125, a recommendation based on the forecasted usage graph. At step 1415, the system outputs, at the evaluation module 135, a recommendation output message based on the recommendation generated by the forecasting output module 125.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
calculating, by a computing device, a request usage and a limit usage for a plurality of pods based on historical data;
generating, by the computing device, a recommendation for pod resources based on the calculated request usage and the calculated limit usage; and
outputting, by the computing device, a recommendation output message for approval which corresponds to the recommendation.

2. The method of claim 1, further comprising generating, by the computing device, a forecasted usage graph which comprises a forecasted usage based on the historical data.

3. The method of claim 2, wherein the recommendation for the pod resources is further based on the forecasted usage graph which comprises the forecasted usage.

4. The method of claim 3, wherein the forecasted usage comprises a forecast of future resource usage.

5. The method of claim 1, wherein the outputting of the recommendation output message for approval occurs via a graphical user interface (GUI) which includes an accept recommendation and a reject recommendation.

6. The method of claim 1, further comprising determining, by the computing device, whether there is at least one pod with both a request and limits missing.

7. The method of claim 6, wherein the generating the recommendation for the pod resources comprises the request being a current usage value and the limits being one of a maximum usage value and the current usage value plus a lower threshold value of the current usage value.

8. The method of claim 1, further comprising determining, by the computing device, whether there is at least one pod with only limits missing.

9. The method of claim 8, wherein the generating the recommendation for the pod resources comprises a request being a current usage value plus a predetermined percentage of a request value and the limits being the request plus a lower threshold value of one of the request and a maximum usage value in response to determining there is at least one pod with only the limits missing and a request usage being less than the lower threshold value of the request value.

10. The method of claim 8, wherein the generating the recommendation for the pod resources comprises the limits being a current request plus a lower threshold value of one of a current request and a maximum usage value in response to determining there is at least one pod with only the limits missing and a request usage not being less than the lower threshold value of a request value.

11. The method of claim 1, further comprising determining, by the computing device, whether there is at least one pod with only a request missing.

12. The method of claim 11, wherein the generating the recommendation for the pod resources comprises the request being a current usage value and limits being a limits usage value plus a predetermined percentage of a limits usage value in response to determining there is at least one pod with only the request missing and the limit usage being greater than an upper threshold value of a limit value.

13. The method of claim 11, wherein the generating the recommendation for the pod resources comprises the request being a current usage value in response to determining there is at least one pod with only the request missing and the limit usage not being greater than an upper threshold value of a limit value.

14. The method of claim 1, further comprising determining, by the computing device, whether there is at least one pod with no missing request and no missing limits.

15. The method of claim 14, wherein the generating the recommendation for the pod resources comprises a request being a current usage plus a predetermined percentage of a request value and the limits being the request plus a lower threshold value of one of the request and a maximum usage value in response to determining that there is the at least one pod with no missing request and no missing limits and a request usage being less than the lower threshold value of the request value.

16. The method of claim 14, wherein the generating the recommendation for the pod resources comprises a limits being a limits usage value plus a predetermined percentage of the limits usage value in response to determining that there is the at least one pod with no missing request and no missing limits, a request usage not being less than a lower threshold value of a request value, and a limit usage being greater than an upper threshold value of the limit value.

17. A computer program product comprising one or more computer readable storage media having program instructions collectively stored on the one or more computer readable storage media, the program instructions executable to:
calculate a request usage and a limit usage for a plurality of pods based on historical data; generate a forecasted usage graph which comprises a forecasted usage based on the historical data;
generate a recommendation for pod resources based on the calculated request usage, the calculated limit usage, and the generated forecasted usage graph which comprises the forecasted usage; and
output a recommendation output message for approval which corresponds to the recommendation.

18. The computer program product of claim 17, wherein the forecasted usage comprises a forecast of future resource usage.

19. The computer program product of claim 17, wherein the program instructions to output the recommendation output message for approval occurs via a graphical user interface (GUI) which includes an accept recommendation button and a reject recommendation button.

20. A system comprising:
a processor, a computer readable memory, one or more computer readable storage media, and program instructions collectively stored on the one or more computer readable storage media, the program instructions executable to:
calculate a request usage and a limit usage for a plurality of pods based on historical
data; generate a forecasted usage graph which comprises a forecasted usage based on the historical data;
generate a recommendation for pod resources based on the calculated request usage, the calculated limit usage, and the generated forecasted usage graph which comprises the forecasted usage; and
output a recommendation output message via a graphical user interface (GUI) for approval which corresponds to the recommendation,
wherein the forecasted usage comprises a forecast of future resource usage.
